(19) United States
(12) Patent Application Publication
(10) Pub. No.: US 2026/0098758 A1
(43) Pub. Date: Apr. 9, 2026

(54) Gas Absorption Spectrometer

(71) Applicants: SHIMADZU CORPORATION, Kyoto-shi (JP); National University Corporation Tokai National Higher Education and Research System, Nagoya-shi (JP)

(72) Inventors: Kazune MANO, Kyoto-shi (JP); Bunta MATSUHANA, Kyoto-shi (JP); Tetsuo FURUMIYA, Kyoto-shi (JP); Hideki TOMITA, Nagoya-shi (JP)

(21) Appl. No.: 19/350,455

(22) Filed: Oct. 6, 2025

(30) Foreign Application Priority Data
Oct. 4, 2024 (JP) 2024-174872

(51) Int. Cl. G01J 3/02; G01J 3/42

(52) U.S. Cl. CPC G01J 3/0286; G01J 3/0202; G01J 3/0291; G01J 3/42

(57) ABSTRACT

A gas absorption spectrometer is a gas absorption spectrometer that measures sample gas, and includes a resonator 100A including at least two mirrors, a laser light source that emits laser beams for irradiation of the resonator 100A, and a photodetector that detects light taken out of the resonator. The resonator includes an inner chamber 1A where mirrors 21 and 22 are accommodated, the inner chamber defining a measurement space 15 where sample gas is to be introduced, an outer chamber 3 arranged outside inner chamber 1A for vacuum insulation of the measurement space 15 from the outside, and a cooler 9 arranged within the outer chamber 3 at a distance from the inner chamber 1A, the cooler including an internal space where coolant flows.

### CROSS REFERENCE TO RELATED APPLICATIONS

This nonprovisional application is based on Japanese Patent Application No. 2024-174872 filed with the Japan Patent Office on October 4, 2024, the entire contents of which are hereby incorporated by reference.

### BACKGROUND OF THE INVENTION

### Field of the Invention

The present disclosure relates to a gas absorption spectrometer configured to obtain a concentration of a target component in gas with cavity ring-down absorption spectroscopy (CRDS) which is a kind of gas absorption spectroscopy.

### Description of the Background Art

Cavity ring-down absorption spectroscopy (CRDS) has been known as one of gas absorption spectroscopic methods. CRDS refers to a spectroscopic technique to obtain with a high degree of sensitivity, a concentration of a target component contained in sample gas by increasing with a resonator (cavity) including a highly reflective mirror, an effective optical path length for optical absorption by sample gas.

Development of A Cavity Ring-Down Spectrometer System for Radiocarbon (¹⁴C) Analyses, Kazune Mano, et al., Shimadzu Review, Vol. 78, [3⋅4], 2021 discloses CRDS for measurement of a radiocarbon isotope ¹⁴C. Since ¹⁴C is only one long-lived radioactive nuclide among isotopes of the element, environmental tracing and/or biological tracing can be achieved by measuring ¹⁴C. At a room temperature, however, absorption intensity of ¹⁴CO₂ is lower by approximately two to three orders of magnitude than absorption intensity of ¹³CO₂ or ¹²CO₂ which is contaminant gas. As will be described later, at an extremely low temperature (approximately -100°C), the absorption intensity of ¹³CO₂ or ¹²CO₂ becomes as low as that of ¹⁴CO₂. Therefore, in order to measure ¹⁴CO₂, sample gas should be cooled to the extremely low temperature (approximately -100°C) to lower the absorption intensity of ¹³CO₂ or ¹²CO₂. A method of bringing a cooler into contact with a resonator has been known as a method of cooling sample gas to the extremely low temperature.

### SUMMARY OF THE INVENTION

As the cooler is brought into contact with the resonator, however, vibration of coolant that flows in the cooler propagates to the resonator, which lowers accuracy in measurement.

This invention was made to solve such a problem, and an object thereof is to provide a cavity ring-down absorption spectrometer capable of accurately measuring a sample at an extremely low temperature.

A gas absorption spectrometer according to the present disclosure is a gas absorption spectrometer configured to measure sample gas, and the gas absorption spectrometer includes a resonator including at least two mirrors, a laser light source configured to emit laser beams for irradiation of the resonator, and a photodetector configured to detect light taken out of the resonator. The resonator includes an inner chamber where the mirrors are accommodated, the inner chamber defining a measurement space where the sample gas is to be introduced, an outer chamber arranged outside the inner chamber for vacuum insulation of the measurement space from the outside, and a cooler arranged within the outer chamber at a distance from the inner chamber, the cooler including an internal space where a coolant flows.

The foregoing and other objects, features, aspects and advantages of this invention will become more apparent from the following detailed description of this invention when taken in conjunction with the accompanying drawings.

### BRIEF DESCRIPTION OF THE DRAWINGS

FIG. 1 is a diagram schematically showing a configuration of a gas absorption spectrometer.

FIG. 2 is a conceptual diagram for illustrating a mode frequency.

FIG. 3 is a diagram illustrating temperature dependency of contaminant gas absorption intensity in the vicinity of a ¹⁴CO₂ absorption peak.

FIG. 4 is a diagram showing a configuration of a resonator according to a comparative example.

FIG. 5 is a diagram showing a configuration of a resonator according to a first embodiment.

FIG. 6 is a diagram showing a configuration of a resonator according to a second embodiment.

FIG. 7 is a diagram showing a configuration of a resonator according to a third embodiment.

FIG. 8 is a diagram showing a configuration of a resonator according to a fourth embodiment.

FIG. 9 is a diagram showing a configuration of a resonator according to a fifth embodiment.

FIG. 10 is a diagram showing a configuration of a resonator according to a sixth embodiment.

FIG. 11 is a diagram showing a configuration of a resonator according to a seventh embodiment.

FIGS. 12 and 13 each show an exemplary joint according to the seventh embodiment.

FIG. 14 is a diagram showing a configuration of a resonator according to a first modification.

### DESCRIPTION OF THE PREFERRED EMBODIMENTS

The present embodiment will be described in detail below with reference to the drawings. The same or corresponding elements in the drawings have the same reference characters allotted below and description thereof will not be repeated.

### Configuration of Gas Absorption Spectrometer

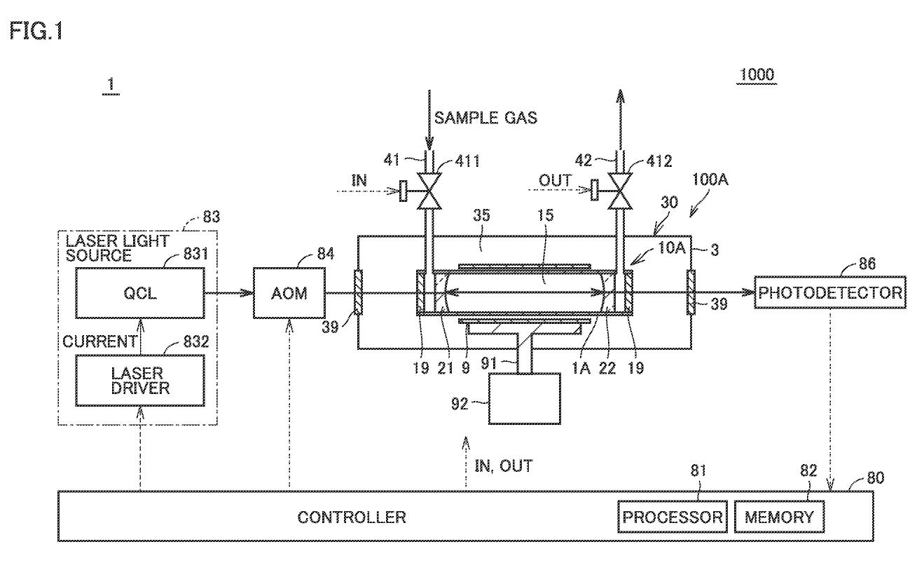

FIG. 1 is a diagram schematically showing a configuration of a gas absorption spectrometer 1000 according to the present embodiment. Gas absorption spectrometer 1000 is configured to measure optical absorption by a target component contained in sample gas, with cavity ring-down absorption spectroscopy (CRDS).

Gas absorption spectrometer 1000 includes a laser light source 83, an acousto-optic modulator (AOM) 84, a resonator 100A, a photodetector 86, and a controller 80.

Laser light source 83 emits laser beams for irradiation of resonator 100A. Laser light source 83 is configured to vary an oscillatory frequency of laser beams in accordance with a command from controller 80. Specifically, laser light source 83 includes distributed feedback quantum cascade laser (QCL) 831 and a laser driver 832. QCL 831 emits laser beams having a central oscillation wave number, for example, of approximately 2200 cm⁻¹ (a wavelength of approximately 4.5 μm). Laser driver 832 supplies a drive current to QCL 831 in accordance with a command from controller 80. By changing the drive current to QCL 831, the oscillation wave number of QCL 831 can be swept by approximately 0.2 cm⁻¹.

AOM 84 is provided in an optical path between laser light source 83 and resonator 100A. AOM 84 is an optical switch (switch) that switches at a high speed, between emission and cut-off of laser beams from laser light source 83 to resonator 100A in accordance with a command from controller 80. AOM 84 enters an on state in which laser beams from laser light source 83 are outputted to resonator 100A, upon application of an on command for irradiation with light from controller 80. AOM 84 enters an off state in which laser beams from laser light source 83 are not outputted to resonator 100A, upon application of an off command for cut-off of light from controller 80.

A configuration of resonator 100A in connection with measurement of sample gas with CRDS will now be described. Resonator 100A is provided in the optical path between AOM 84 and photodetector 86. Resonator 100A includes a container (an inner chamber 1A which will be described later) where sample gas is sealed, the container defining a measurement space 15, an introduction pipe 41 for introduction of sample gas into resonator 100A before start of measurement, and an exhaust pipe 42 for exhaust of sample gas to the outside of resonator 100A after end of measurement. An introduction valve 411 is provided at introduction pipe 41. An exhaust valve 412 is provided at exhaust pipe 42. Opening and closing of introduction valve 411 and exhaust valve 412 is also controllable by controller 80.

Resonator 100A includes at least two mirrors. In an example in FIG. 1, a pair of mirrors 21 and 22 is provided inside resonator 100A. Mirrors 21 and 22 are arranged as being opposed to each other such that light is reflected therebetween within resonator 100A. In order to readily satisfy a condition for stabilization of resonator 100A, a mirror having at least one concave surface is adopted as each of mirrors 21 and 22. In addition, a mirror with high (for example, approximately 99.9%) reflectivity is adopted as each of mirrors 21 and 22 such that light that leaks to the outside of resonator 100A is extremely weak. A resonator length (a distance in a direction of an optical axis AX between mirrors 21 and 22) of resonator 100A is, for example, approximately 450 mm. The number of mirrors to be arranged inside resonator 100A is not limited to two, and three or more mirrors may be arranged. In other words, a resonator where mirrors are arranged such that light is reflected among them or a resonator in which mirrors are arranged in a ring such that light is reflected in one direction may be applicable.

A not-shown piezoelectric element (piezo element) is arranged at mirror 21 and/or mirror 22. The piezoelectric element displaces mirror 21 and/or mirror 22 in the direction of the optical axis by driving mirror 21 and/or mirror 22 included in resonator 100A in accordance with a command from controller 80. The resonator length of resonator 100A can thus be varied. Therefore, the resonator length can be varied to adapt to the wave number of laser, or the wave number of laser can be swept to adapt to the resonator length.

Sample gas in resonator 100A is cooled by a cooler 9 in the present embodiment. A configuration in connection with cooling will be described later.

Photodetector 86 detects light taken out of resonator 100A. Photodetector 86 is a photodetector such as a photodiode or an image sensor. Photodetector 86 detects weak light taken out of resonator 100A as output light of resonator 100A and outputs a signal indicating a result of detection thereof (detection signal) to controller 80. For example, a liquid nitrogen cooled indium antimony (InSb) detector can be adopted as photodetector 86.

Controller 80 includes a processor 81 such as a central processing unit (CPU) or a field-programmable gate array (FPGA), a memory 82 such as a read only memory (ROM) and a random access memory (RAM), and an input and output port (not shown).

Controller 80 is a control device that measures a target component in sample gas within resonator 100A based on an output signal from photodetector 86. Controller 80 controls each device included in gas absorption spectrometer 1000. Specifically, controller 80 outputs a command for scanning an oscillatory frequency of laser beams to laser driver 832 or outputs the on signal or the off signal described above to AOM 84. Controller 80 outputs a command for introduction of sample gas into resonator 100A to introduction valve 411 or outputs a command for exhaust of sample gas to the outside of resonator 100A to exhaust valve 412. Controller 80 has a voltage for displacement of mirror 22 applied to a piezoelectric element. Controller 80 performs various types of data processing for calculating a concentration (absolute concentration) of the target component contained in sample gas based on the detection signal from photodetector 86.

Controller 80 may be configured as being divided into two or more units for each function. For example, controller 80 may be divided into a unit configured to control each device and a unit configured to perform various types of data processing.

### Principles of Measurement with Cavity Ring-Down Absorption Spectroscopy (CRDS)

Principles of measurement with cavity ring-down absorption spectroscopy in gas absorption spectrometer 1000 will briefly be described. In general, for a resonator, there is a resonance condition that resonance occurs when light emitted to the resonator has a specific frequency. A frequency of laser beams emitted to resonator 100A will be referred to as a "laser frequency" below and a frequency of light at which resonance may be caused by resonator 100A is referred to as a "mode frequency" below.

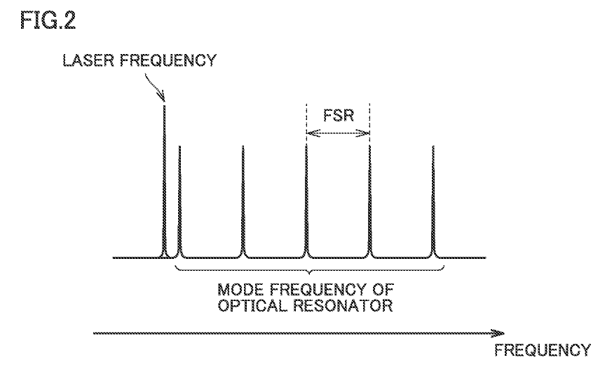

FIG. 2 is a conceptual diagram for illustrating the mode frequency. As shown in FIG. 2, there are a plurality of mode frequencies at prescribed frequency intervals. An interval between two mode frequencies adjacent among a plurality of mode frequencies is referred to as a free spectral range (FSR) below.

When the laser frequency does not coincide with any mode frequency, power of light is not stored in resonator 100A. When the laser frequency coincides with any mode frequency, on the other hand, power of light is stored in resonator 100A.

Controller 80 determines whether or not power of laser beams has sufficiently been accumulated in resonator 100A based on the output signal from photodetector 86 (output light from resonator 100A). When output light from resonator 100A reaches a predetermined threshold value, controller 80 determines that power of laser beams has sufficiently been accumulated in resonator 100A and outputs the off signal to AOM 84. Light inputted to resonator 100A is thus cut off by AOM 84. Then, light stored in resonator 100A travels between mirror 21 and mirror 22 a large number of times (normally, several thousand times to several ten thousand times). While this light travels between mirrors 21 and 22, it gradually attenuates due to loss by reflection by mirrors 21 and 22 and absorption by the target component in sample gas. Therefore, output light from resonator 100A that leaks from mirror 22 gradually attenuates. In CRDS, a distance by which light passes through sample gas (execution optical path length) is made longer with the use of resonator 100A, so that optical absorption by the target component can be detected even when the optical absorption is extremely slight.

Controller 80 obtains as a "ring-down signal," the output signal from photodetector 86 after light inputted to resonator 100A has been cut off by AOM 84 and calculates a time constant of attenuation of the obtained ring-down signal as "ring-down time." Controller 80 calculates a concentration of the target component contained in sample gas from the calculated ring-down time.

Controller 80 obtains the output signal from photodetector 86, for example, every 0.2 μsec. and calculates the ring-down time based on the obtained output signal from photodetector 86. When there is no gas component that absorbs laser beams within resonator 100A, the ring-down time is the time constant of attenuation by resonator 100A and it has an approximately constant value. When there is a gas component that absorbs laser beams within resonator 100A, on the other hand, the ring-down time has a value that varies in accordance with the concentration of the gas component. By making use of this aspect, the concentration of the target component can be quantified.

### Measurement of 14C

A radiocarbon isotope ¹⁴C which is only one long-lived radioactive nuclide among isotopes of the element is used as an environmental tracer. For example, by measuring an abundance ratio of ¹⁴C in an organic resource, whether the organic resource is biomass derived from a plant or fossil fuel can be determined. ¹⁴C is used also as a biological tracer. In development of drugs, a compound, some of carbon of which is labeled with ¹⁴C, is administered to a living body, and a concentration of ¹⁴C accumulated in blood, urine, feces, and organs thereof can be measured to analyze in vivo kinetics of the administered compound.

An isotope ratio of ¹⁴C, however, is very low. Therefore, in measurement of ¹⁴C, ¹⁴C should be distinguished from other carbon isotopes and detected at a high degree of sensitivity.

In laser absorption spectroscopy, making use of a difference in wavelength of absorbed infrared light depending on isotopes in a molecule, an isotopic molecule can be analyzed. In CRDS, sensitivity is improved by making an effective optical path length longer with an optical resonator.

In order to detect ¹⁴C at a higher degree of sensitivity, it is helpful to cool sample gas. At a room temperature, absorption intensity of ¹⁴CO₂ is lower by approximately two to three orders of magnitude than absorption intensity of ¹²CO₂ or ¹³CO₂ which is contaminant gas. By cooling sample gas, however, absorption intensity of ¹²CO₂ or ¹³CO₂ can be lowered.

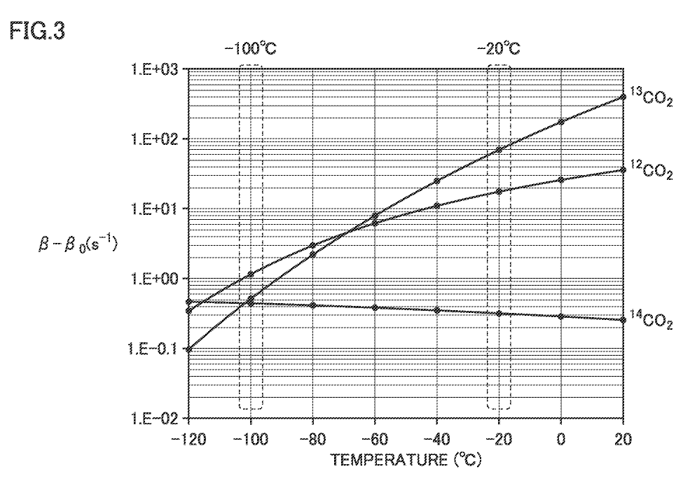

FIG. 3 is a diagram illustrating temperature dependency of contaminant gas absorption intensity in the vicinity of a ¹⁴CO₂ absorption peak. The abscissa in FIG. 3 represents a temperature and the ordinate represents gas absorption intensity. It can be seen with reference to FIG. 3 that, when ¹⁴CO₂ is cooled to an extremely low temperature (-100°C), absorption intensity of ¹⁴CO₂ is close to absorption intensity of ¹²CO₂ or ¹³CO₂. Measurement in a state different from the state at the room temperature can thus be conducted by cooling sample gas.

### Comparative Example

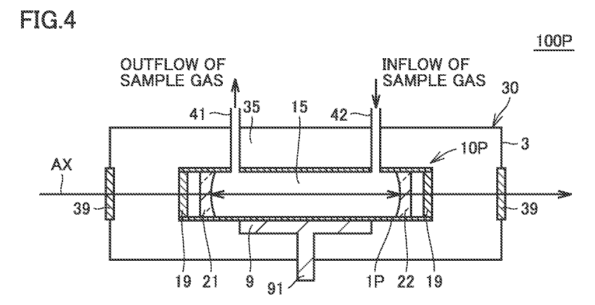

FIG. 4 is a diagram showing a configuration of a resonator 100P according to a comparative example. In resonator 100P, sample gas is measured within an inner chamber unit 10P. Sample gas is then cooled by bringing inner chamber unit 10P in direct contact with cooler 9 to cool the same. In resonator 100P, however, vibration of coolant that flows within cooler 9 may propagate to inner chamber unit 10P and affect measurement with CRDS. Specifically, as mirrors 21 and 22 in inner chamber unit 10P vibrate, accuracy in measurement with CRDS may become poor.

### First Embodiment

FIG. 5 is a diagram showing a configuration of resonator 100A according to a first embodiment. Resonator 100A includes an inner chamber unit 10A, an outer chamber unit 30, introduction pipe 41, exhaust pipe 42, and cooler 9.

Inner chamber unit 10A includes an inner chamber 1A, mirrors 21 and 22, and a window material 19.

Mirrors 21 and 22 are accommodated in inner chamber 1A, and inner chamber 1A defines measurement space 15 in which sample gas is to be introduced. Inner chamber 1A includes mirror holding portions (mirror holder) 11A where mirrors 21 and 22 are provided and a cooled portion 12A between mirror holding portions 11A. Inner chamber 1A is, for example, a cylindrical member. As window material 19 seals an opening of inner chamber 1A, the inside of inner chamber unit 10A is hermetically sealed.

Outer chamber unit 30 includes an outer chamber 3 and a window material 39. Outer chamber 3 is arranged outside inner chamber 1A and vacuum insulates measurement space 15 from the outside. Outer chamber 3 is, for example, a cylindrical member. As window material 39 seals an opening of outer chamber 3, the inside of outer chamber unit 30 is hermetically sealed.

Inner chamber unit 10A and outer chamber unit 30 are arranged such that window material 39, window material 19, and mirrors 21 and 22 are located on an optical axis AX that extends between laser light source 83 and photodetector 86. Laser beams emitted from laser light source 83 enter inner chamber unit 10A arranged within outer chamber unit 30, they are reflected by mirrors 21 and 22, and thereafter they are detected by photodetector 86.

Cooler 9 includes a cooler main body 99. Cooler main body 99 contains an internal space where a coolant flows. In one example, coolant cooled by a coolant cooling portion 92 is supplied to cooler main body 99 through a pipe 91. Cooler main body 99 and pipe 91 and/or coolant cooling portion 92 may be configured as being integrated. A figure that will follow does not show coolant cooling portion 92.

Cooler 9 is arranged within outer chamber 3 at a distance from inner chamber 1A. Cooler 9 thus cools inner chamber 1A by radiation. Sample gas in inner chamber 1A is thus cooled. Preferably, cooler 9 is arranged as being opposed to cooled portion 12A of inner chamber 1A. Since inner chamber 1A and cooler 9 are not in contact with each other, vibration of cooler 9 caused by flow of coolant in cooler 9 does not propagate to inner chamber 1A. Sample gas can thus be cooled without deterioration of measurement accuracy of resonator 100A. Therefore, with resonator 100A, a sample at an extremely low temperature can accurately be measured.

An additional feature of the first embodiment will now be described.

Cooler 9 may further include a cooling block 95 as in an example in FIG. 5. Cooling block 95 is a member for improving efficiency in cooling by radiation within inner chamber 1A by cooler main body 99. Cooling block 95 is provided between inner chamber 1A and cooler main body 99 or preferably between cooled portion 12A and cooler main body 99 at a distance from inner chamber 1A. Cooling block 95 is preferably arranged to partially be in contact with cooler main body 99. An area of a surface (a surface shown with a reference 950 in FIG. 5) of cooling block 95 opposed to inner chamber 1A is configured to be larger than an area of a surface (a surface shown with a reference 990 in FIG. 5) of cooler main body 99 opposed to inner chamber 1A.

Inner chamber 1A can more efficiently be cooled in the presence of cooling block 95 than in the absence of cooling block 95. Since inner chamber 1A and cooling block 95 are not in contact with each other, vibration of cooling block 95 caused by flow of coolant in cooler main body 99 does not propagate to inner chamber 1A. Therefore, with cooling block 95 in addition to cooler main body 99, efficiency in cooling of sample gas can be improved while measurement accuracy of resonator 100A is maintained.

Preferably, cooler 9 is arranged around inner chamber 1A to cover the same. Specifically, for example, cooler 9 itself may be formed as a cylindrical member that surrounds inner chamber 1A, or a cylindrical member formed to surround inner chamber 1A may be employed. According to such a configuration, an outer circumference of inner chamber 1A is widely opposed to cooler 9, and hence cooling efficiency can be improved.

By forming cooling block 95 from a member high in thermal conductivity, a temperature of cooling block 95 can readily be lowered. An exemplary member high in thermal conductivity is metal, and more specifically copper.

By forming inner chamber 1A of a material high in radiation factor, inner chamber 1A can efficiently be cooled. More specifically, in inner chamber 1A, cooled portion 12A corresponding to a most part of measurement space 15 where sample gas is located is preferably formed of a material having a radiation factor larger than a prescribed value. More specifically, cooled portion 12A is preferably formed of a material having the radiation factor larger than 0.8. In this case, a sufficient radiation effect can be expected. The material having the radiation factor larger than 0.8 is, for example, any of quartz glass, an anodized aluminum material, and a material obtained by painting the anodized aluminum material with white or black.

By forming inner chamber 1A of a material low in coefficient of thermal expansion, variation in resonator length is slight even when inner chamber 1A is cooled. More specifically, in inner chamber 1A, cooled portion 12A corresponding to a most part of the resonator length is preferably formed of a material low in coefficient of thermal expansion. The resonator length is thus stable toward variation in temperature. The material low in coefficient of thermal expansion is more specifically a material lower in coefficient of thermal expansion than metal, and it is, for example, quartz glass.

As set forth above, by forming inner chamber 1A of quartz glass, inner chamber 1A can efficiently be cooled and variation in resonator length caused by cooling can be less.

As set forth above, according to resonator 100A according to the first embodiment, a cavity ring-down absorption spectrometer with which a sample at an extremely low temperature can accurately be measured can be provided.

### Use of Thermally Conductive Material That Does Not Allow Propagation of Vibration Therethrough

An embodiment in which a thermally conductive material that is arranged between the inner chamber and the cooler and mediates thermal conduction between the inner chamber and the cooler is further included will now be described. In the present embodiment, the thermally conductive material is a material that is less likely or substantially unlikely to allow vibration of the cooler to propagate to the inner chamber even when it is in contact with both of the cooler and the inner chamber. More specifically, the thermally conductive material is a material that is less likely or substantially unlikely to allow vibration of a portion thereof in contact with the cooler to propagate to a portion thereof in contact with the inner chamber even when the former portion vibrates. In other words, the thermally conductive material is configured such that a behavior of the portion thereof in contact with the cooler and a behavior of the portion thereof in contact with the inner chamber are not in coordination with each other. An exemplary thermally conductive material is, for example, gas (fourth embodiment), liquid, or highly flexible solid. The highly flexible solid refers, for example, to a solid (second embodiment) formed in a wool shape or a solid (third embodiment) formed in a strap shape. Naturally, a highly thermally conductive material is preferably employed as the thermally conductive material.

### Second Embodiment

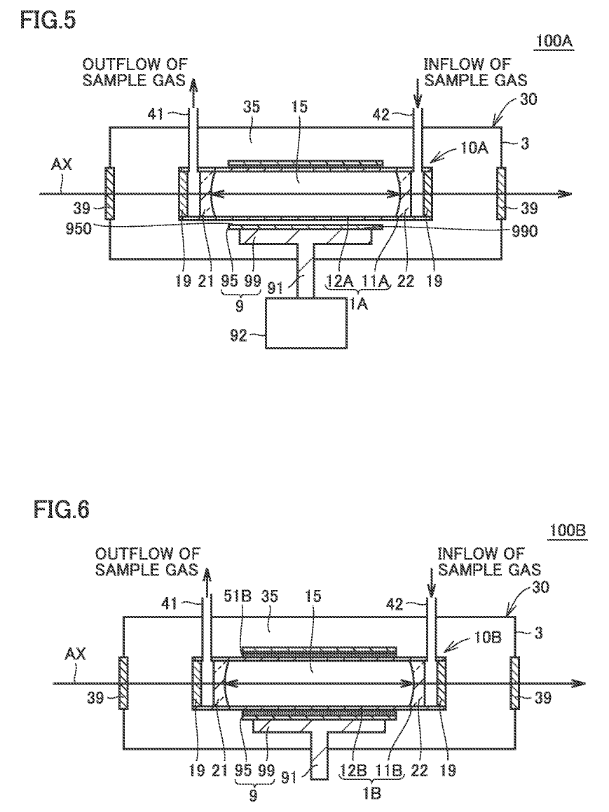

FIG. 6 is a diagram showing a configuration of a resonator 100B according to a second embodiment. Resonator 100B includes wool 51B in addition to the features of resonator 100A. Wool 51B is arranged between an inner chamber 1B and cooler 9 and more specifically it connects inner chamber 1B and cooler 9 to each other. Wool 51B corresponds to one example of the "thermally conductive material." Wool 51B is preferably formed of a highly thermally conductive material, and it is formed, for example, of metal such as copper. According to the second embodiment, inner chamber 1B can be cooled by using not only radiation by cooler 9 but also thermal conduction by wool 51B. Therefore, while propagation of vibration of cooler 9 to inner chamber 1B is suppressed, efficiency in cooling of inner chamber 1B can be improved. Preferably, wool 51B has a thermal conductivity not lower than 100 W/m•K. In other words, wool 51B is preferably formed of a material (for example, diamond, copper, gold, aluminum, or brass) having a thermal conductivity not lower than 100 W/m•K. According to such a configuration, efficient cooling can be achieved.

### Third Embodiment

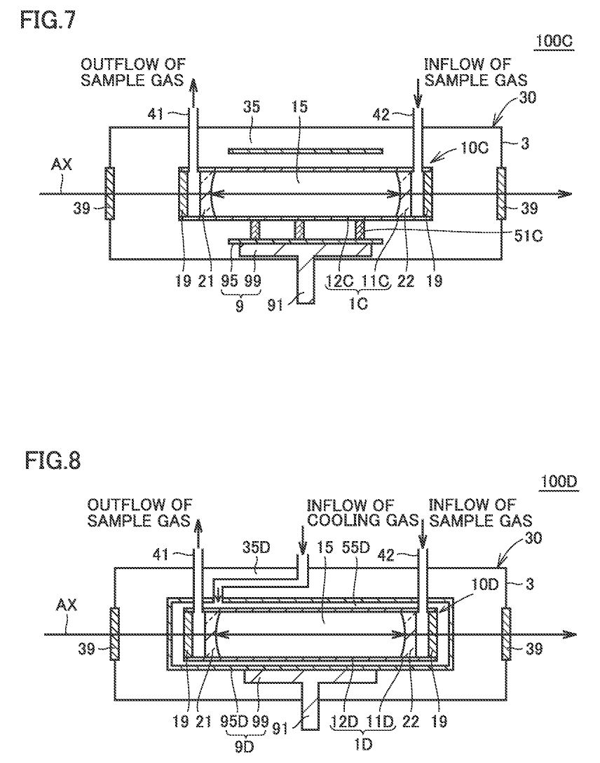

FIG. 7 is a diagram showing a configuration of a resonator 100C according to a third embodiment. Resonator 100C includes a thermal strap 51C in addition to the features of resonator 100A. Thermal strap 51C is arranged between an inner chamber 1C and cooler 9 and more specifically it connects inner chamber 1C and cooler 9 to each other. Thermal strap 51C corresponds to one example of the "thermally conductive material." Thermal strap 51C is preferably formed of a highly thermally conductive material, and formed, for example, of metal such as copper, aluminum, indium, or gold. According to the third embodiment, inner chamber 1C can be cooled by using not only radiation by cooler 9 but also thermal conduction by thermal strap 51C. Therefore, while propagation of vibration of cooler 9 to inner chamber 1C is suppressed, efficiency in cooling of inner chamber 1C can be improved. Preferably, thermal strap 51C has a thermal conductivity not lower than 100 W/m•K. In other words, thermal strap 51C is preferably formed of a material (for example, diamond, copper, gold, aluminum, or brass) having the thermal conductivity not lower than 100 W/m•K. According to such a configuration, efficient cooling can be achieved.

### Fourth Embodiment

FIG. 8 is a diagram showing a configuration of a resonator 100D according to a fourth embodiment. Resonator 100D includes a cooling block 95D instead of cooling block 95 of resonator 100A. Cooling block 95D is a housing arranged such that an inner chamber unit 10D is accommodated therein. Cooling block 95D hermetically seals the inside thereof.

A space 35D between outer chamber 3 and cooling block 95D is evacuated. Cooling block 95D is thus vacuum insulated from the outside.

In a space 55D between cooling block 95D and an inner chamber unit 10D, gas for cooling (which will also be referred to as "cooling gas" below) which is gas that mediates thermal conduction between inner chamber 1D and cooler 9 is filled. Cooling gas corresponds to one example of the "thermally conductive material." One example of cooling gas is nitrogen (N₂) gas. Cooling gas loses heat to cooler 9 and removes heat from inner chamber 1D while cooling gas carries out convection in space 55D. As set forth above, according to the fourth embodiment, inner chamber 1D can be cooled by using not only radiation by cooler 9 but also thermal conduction by cooling gas that carries out convection. Therefore, while propagation of vibration of cooler 9 to inner chamber 1D is suppressed, efficiency in cooling of inner chamber 1D can be improved.

Since cooling gas and cooling block 95D are located on optical axis AX of laser beams, they are preferably formed of a material that does not interfere with measurement of sample gas.

By filling not only the inside of inner chamber unit 10D but also surroundings thereof with gas as in resonator 100D, possibility of leakage of sample gas (occurrence of leakage of sample gas) to the surroundings of inner chamber unit 10D due to a differential pressure between the inside and the surroundings of inner chamber unit 10D is lowered. A rate of leakage is in proportion to a pressure difference between the inside and the outside of inner chamber unit 10D. Therefore, cooling gas is preferably filled such that a barometric pressure in space 55D is approximately as high as a barometric pressure in inner chamber unit 10D. In one example, cooling gas is filled, for example, such that the barometric pressure in space 55D is approximately one time to ten times as high as the barometric pressure in inner chamber unit 10D.

Even if a sufficient cooling effect by cooling by radiation by the cooler shown in the first embodiment cannot be expected and/or even if a rate of thermal conduction is low and accuracy in temperature adjustment is insufficient with cooling by radiation, by using the thermally conductive materials as shown in the second to fourth embodiments, thermal conduction between the inner chamber and the cooler can be mediated without propagation of vibration. The inner chamber can thus sufficiently be cooled or the rate of thermal conduction can be increased to improve accuracy in temperature adjustment. More specifically, even if radiation alone is unable, due to thermal disturbance or loss, to stabilize a temperature of the inner chamber that has been reached, the temperature can be stabilized by using the thermally conductive material.

### Use of Inner Chamber Formed of a Plurality of Types of Materials

An embodiment where an inner chamber formed of two or more types of materials different in property from each other is included will now be described.

### Fifth Embodiment

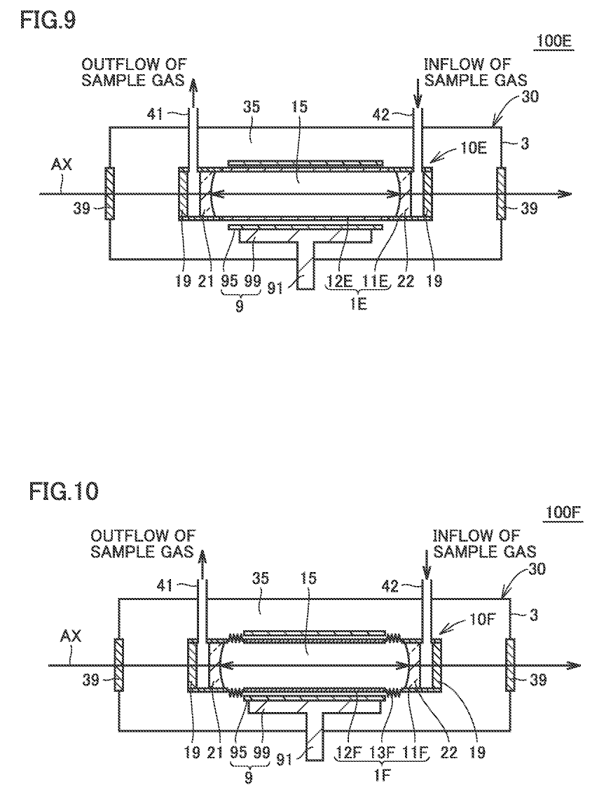

FIG. 9 is a diagram showing a configuration of a resonator 100E according to a fifth embodiment. Resonator 100E includes an inner chamber 1E instead of inner chamber 1A of resonator 100A.

A mirror holding portion 11E of inner chamber 1E is preferably formed of a material low in thermal conductivity and more specifically formed of a material lower in thermal conductivity than metal. Mirrors 21 and 22 are thus less likely to be cooled. In one example, mirror holding portion 11E is formed of quartz glass.

In an example in FIG. 9, mirror holding portion 11E and a cooled portion 12E are connected to each other by laser welding. Since laser welding allows linear connection between mirror holding portion 11E and cooled portion 12E, an area of connection can be small and a thermally insulating effect can be enhanced. Mirror holding portion 11E and mirrors 21 and 22 are thus less likely to be cooled. Cooled portion 12E is formed of a material (for example, metal) that can be welded to quartz glass by laser. In one example, cooled portion 12E is formed of Kovar™ metal.

As set forth above, owing to both of the low thermal conductivity of mirror holding portion 11E and the low thermal conductivity at linear contact between cooled portion 12E and mirror holding portion 11E, mirrors 21 and 22 are less likely to be cooled even when cooled portion 12E is cooled. As mirrors 21 and 22 are less likely to be cooled, condensation at surfaces of mirrors 21 and 22 due to cooling of mirrors 21 and 22 is less likely. In addition, possibility of failure due to cooling, of the piezoelectric element (not shown) arranged at mirrors 21 and 22 for adjustment of the resonator length can be lowered.

### Sixth Embodiment

FIG. 10 is a diagram showing a configuration of a resonator 100F according to a sixth embodiment. Resonator 100F includes an inner chamber 1F instead of inner chamber 1A of resonator 100A.

Inner chamber 1F includes a mirror holding portion 11F, a cooled portion 12F, and a welded bellows 13F. Welded bellows 13F connects mirror holding portion 11F and cooled portion 12F to each other. With welded bellows 13F, thermal conduction between mirror holding portion 11F and cooled portion 12F can be lessened. In addition, change in position of mirror holding portion 11F due to shrinkage of cooled portion 12F can also be lessened. A component that connects mirror holding portion 11F and cooled portion 12F to each other like welded bellows 13F will herein also be referred to as a "joint".

As shown above, welded bellows 13F of resonator 100F can suppress thermal conduction and lessen influence by thermal shrinkage, similarly to laser welding in resonator 100E. Therefore, since mirrors 21 and 22 are less likely to be cooled also in resonator 100F, condensation at the surfaces of mirrors 21 and 22 is less likely. In addition, possibility of failure due to cooling, of the piezoelectric element (not shown) arranged at mirrors 21 and 22 for adjustment of the resonator length can be lowered. Welded bellows 13F may be a molded bellows or a softer bellows.

Preferably, by fixing a position of mirror holding portion 11F within resonator 100F within outer chamber 3 with a member low in coefficient of expansion, stability of the resonator length toward variation in temperature can further be improved.

Cooled portion 12F is preferably formed of a material high in cooling efficiency and radiation factor, and it is formed, for example, of black anodized aluminum. Mirror holding portion 11F is formed, for example, of an Invar alloy.

### Use of Joint Composed of Combination of a Plurality of Types of Materials

An embodiment in which a joint formed of at least two types of materials different in property from each other is used will now be described. More specifically, by connecting a mirror holding portion and a cooled portion of an inner chamber with a joint which is combination of a "material having a thermal conductivity not higher than 1" and a "highly extendable material," the resonator length can be stabilized and the thermal conductivity can be lowered.

### Seventh Embodiment

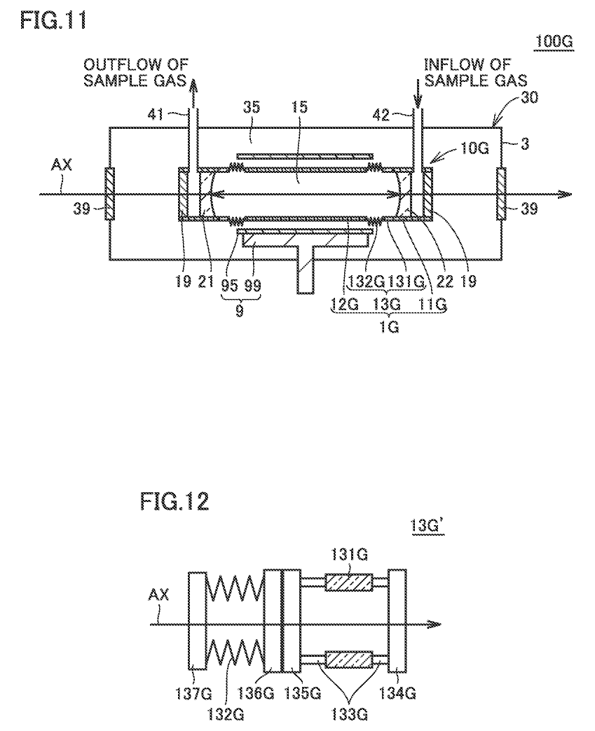

FIG. 11 is a diagram showing a configuration of a resonator 100G according to a seventh embodiment. Resonator 100G includes an inner chamber 1G instead of inner chamber 1A of resonator 100A. Inner chamber 1G includes a mirror holding portion 11G, a cooled portion 12G, and a joint 13G. Joint 13G includes a thermally insulating member 131G and an extendable member 132G.

In the seventh embodiment, with the joint which is combination of thermally insulating member 131G and extendable member 132G, vibration and position displacement of mirrors 21 and 22 can be less and a resonator length can be kept stabler than in an example where a joint composed only of thermally insulating member 131G is employed. In addition, such a problem as condensation due to cooling of mirrors 21 and 22 can be alleviated as compared with an example where a joint composed only of extendable member 132G is employed.

FIGS. 12 and 13 each show an exemplary joint 13G according to the seventh embodiment.

FIG. 12 discloses a joint 13G' which is obtained by joining to each other, thermally insulating member 131G and extendable member 132G that are formed independently of each other. According to such a configuration, each of thermally insulating member 131G and extendable member 132G alone can readily be diverted also to another application, or combination of a type of thermally insulating member 131G and a type of extendable member 132G can readily be changed.

FIG. 13 discloses a joint 13G'' obtained by integrating thermally insulating member 131G and extendable member 132G. According to such a configuration, time and efforts to join independent thermally insulating member 131G and independent extendable member 132G to each other for use in resonator 100G in FIG. 11 can be saved.

Support members 133G to 137G in FIGS. 12 and 13 support thermally insulating member 131G and/or extendable member 132G. Support members 133G to 137G are provided, in the center, with a hole for passage of laser beams therethrough, or formed from a material that allows transmission of laser beams therethrough. Support members 133G to 137G are, for example, flanges made of metal.

Thermally insulating member 131G is formed of a material having a thermal conductivity not higher than 1.

An exemplary material for thermally insulating member 131G is glass which is low in thermal conductivity and readily joined to metal. Exemplary glass is Kovar glass close in coefficient of thermal expansion to Kovar metal. Thermally insulating member 131G is, for example, a flange made of glass.

Another exemplary material for thermally insulating member 131G is rubber. Thermally insulating member 131G is, for example, a rubber tube. Since it is difficult to integrally form the rubber tube and the welded bellows, it is appropriate to form them as separate components as shown in FIG. 12. In this case, the rubber tube is connected to the flange (any of support members 133G to 135G) with a hose band or the like.

Extendable member 132G is formed of a highly extendable material. An exemplary extendable member 132G is the welded bellows. With the welded bellows, as set forth above, thermal conduction from cooled portion 12G to mirror holding portion 11G can be suppressed and change in position of mirror holding portion 11G due to thermal shrinkage of cooled portion 12G can be lessened. The welded bellows may be a molded bellows or a softer bellows.

In one example, joint 13G is arranged such that thermally insulating member 131G is located on a side of mirror holding portion 11G and extendable member 132G is located on a side of cooled portion 12G. In particular, in an example where extendable member 132G is the welded bellows, owing to the thermally insulating effect of the welded bellows itself, thermally insulating member 131G is cooled less than in an example where it is located on the side of cooled portion 12G. For example, in an example where thermally insulating member 131G is made of rubber, deterioration of rubber by cooling can thus be lessened.

### First Modification

The joint as shown in FIGS. 12 and 13 can also be incorporated in another resonator, and by incorporation, propagation of vibration to mirrors 21 and 22 can be lessened and cooling of mirrors 21 and 22 can be suppressed.

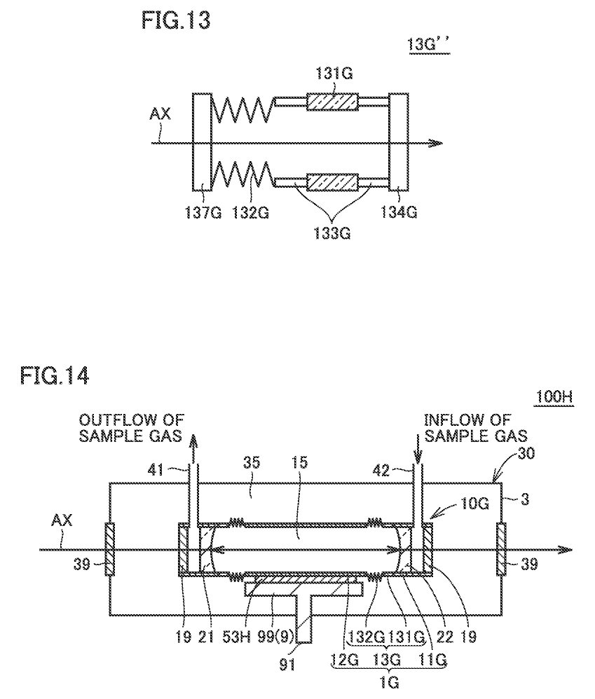

FIG. 14 is a diagram showing a configuration of a resonator 100H according to a first modification. Resonator 100H according to the first modification includes a cooling plate 53H in addition to the features of resonator 100G. Cooling plate 53H is, for example, a copper plate. In resonator 100H, though vibration of cooler 9 is more likely to propagate to cooled portion 12G than in resonator 100G, conduction to mirrors 21 and 22 is mitigated by joint 13G. Though cooled portion 12G is more likely to be cooled in resonator 100H than in resonator 100G, cooling of mirrors 21 and 22 is mitigated by joint 13G.

Exemplary extendable member 132G included in joint 13G is the welded bellows as above. With the welded bellows, thermal conduction from cooled portion 12G to mirror holding portion 11G can be suppressed and change in position of mirror holding portion 11G due to thermal shrinkage of cooled portion 12G can be lessened, and propagation of vibration of cooler 9 to mirror holding portion 11G can be lessened. The welded bellows may be a molded bellows or a softer bellows. From a point of view of suppression of vibration of mirrors 21 and 22, a spring constant of the welded bellows is preferably not higher than 70 N/mm in an axial direction.

When use of cooling plate 53H does not seem to interfere with measurement based on characteristics or the like of gas to be detected and cooler 9, resonator 100H can be used for measurement. In using resonator 100H, when cooled portion 12G is sufficiently cooled simply by thermal conduction by cooling plate 53H, a cooling block for improvement in efficiency of cooling by radiation does not have to be provided.

The features according to the embodiments and the modification described previously can be combined as appropriate unless they are obstructive to each other. For example, the thermally conductive materials shown in the second to fourth embodiments and the inner chambers formed from the plurality of types of members shown in the fifth to seventh embodiments can be used together to lessen variation in resonator length caused by cooling of the cooled portion and possibility of condensation or the like due to cooling of the mirror holding portion while an effect to cool the cooled portion of the inner chamber is enhanced.

It should be understood that the embodiments disclosed herein are illustrative and non-restrictive in every respect. The scope of the present invention is defined by the terms of the claims rather than the description of the embodiments above and is intended to include any modifications within the scope and meaning equivalent to the terms of the claims.

### Aspects

The embodiments and the modification thereof described above are understood by a person skilled in the art as specific examples of aspects below.

(Clause 1) A gas absorption spectrometer according to the present disclosure is a gas absorption spectrometer configured to measure sample gas, and the gas absorption spectrometer includes a resonator including at least two mirrors, a laser light source configured to emit laser beams for irradiation of the resonator, and a photodetector configured to detect light taken out of the resonator. The resonator includes an inner chamber where the mirrors are accommodated, the inner chamber defining a measurement space where sample gas is to be introduced, an outer chamber arranged outside the inner chamber for vacuum insulation of the measurement space from the outside, and a cooler arranged within the outer chamber at a distance from the inner chamber, the cooler including an internal space where a coolant flows. In the gas absorption spectrometer described in Clause 1, since the inner chamber and the cooler are not in contact with each other, vibration of the cooler caused by flow of coolant in the cooler does not propagate to the inner chamber. Sample gas can thus be cooled without deterioration of measurement accuracy of the resonator. Therefore, with the resonator, a sample at an extremely low temperature can accurately be measured.

(Clause 2) In the gas absorption spectrometer described in Clause 1, the cooler is arranged around the inner chamber to cover the same. In the gas absorption spectrometer described in Clause 2, since the outer circumference of the inner chamber is widely opposed to the cooler, cooling efficiency can be improved.

(Clause 3) The gas absorption spectrometer described in Clause 1 or 2 further includes a thermally conductive material arranged between the inner chamber and the cooler, the thermally conductive material being configured to mediate thermal conduction between the inner chamber and the cooler. In the gas absorption spectrometer described in Clause 3, even when a sufficient cooling effect by cooling by radiation by the cooler cannot be expected and/or even when a rate of thermal conduction is low and accuracy in temperature adjustment is insufficient with cooling by radiation, with the thermally conductive material, sufficient cooling can be achieved and the rate of thermal conduction can be increased to improve accuracy in temperature adjustment.

(Clause 4) In the gas absorption spectrometer described in Clause 3, the thermally conductive material is in a wool shape. In the gas absorption spectrometer described in Clause 4, while propagation of vibration of the cooler to the inner chamber is suppressed, efficiency in cooling of the inner chamber can be improved.

(Clause 5) In the gas absorption spectrometer described in Clause 4, the thermally conductive material has a thermal conductivity not lower than 100 W/m•K. In the gas absorption spectrometer described in Clause 5, efficient cooling can be achieved.

(Clause 6) In the gas absorption spectrometer described in Clause 3, the thermally conductive material is in a strap shape. In the gas absorption spectrometer described in Clause 6, while propagation of vibration of the cooler to the inner chamber is suppressed, efficiency in cooling of the inner chamber can be improved.

(Clause 7) In the gas absorption spectrometer described in Clause 6, the thermally conductive material has a thermal conductivity not lower than 100 W/m•K. In the gas absorption spectrometer described in Clause 7, efficient cooling can be achieved.

(Clause 8) In the gas absorption spectrometer described in Clause 3, the thermally conductive material includes gas for cooling. In the gas absorption spectrometer described in Clause 8, while propagation of vibration of the cooler to the inner chamber is suppressed, efficiency in cooling of the inner chamber can be improved.

(Clause 9) In the gas absorption spectrometer described in any one of Clauses 1 to 3, the inner chamber includes mirror holding portions where the mirrors are provided and a cooled portion between the mirror holding portions. The cooled portion is formed of a material having a radiation factor larger than a prescribed value. In the gas absorption spectrometer described in Clause 9, inner chamber 1A can efficiently be cooled.

(Clause 10) In the gas absorption spectrometer described in Clause 9, the prescribed value is 0.8. In the gas absorption spectrometer described in Clause 10, a sufficient radiation effect can be expected.

(Clause 11) In the gas absorption spectrometer described in any one of Clauses 1 to 3 and 9 to 10, the inner chamber includes mirror holding portions where the mirrors are provided and a cooled portion between the mirror holding portions. The cooled portion is formed of a material lower in coefficient of thermal expansion than metal. In the gas absorption spectrometer described in Clause 11, the resonator length is stable toward variation in temperature.

(Clause 12) In the gas absorption spectrometer described in any one of Clauses 1 to 3 and 9 to 11, the inner chamber includes mirror holding portions where the mirrors are provided and a cooled portion between the mirror holding portions. The mirror holding portions are formed of a material lower in thermal conductivity than metal. In the gas absorption spectrometer described in Clause 12, the mirror is less likely to be cooled.

(Clause 13) In the gas absorption spectrometer described in any one of Clauses 1 to 3 and 9 to 12, the inner chamber includes mirror holding portions where the mirrors are provided and a cooled portion between the mirror holding portions. The mirror holding portions and the cooled portion are connected to each other by a welded bellows. In the gas absorption spectrometer described in Clause 13, the mirror is less likely to be cooled.

(Clause 14) In the gas absorption spectrometer described in any one of Clauses 1 to 3 and 9 to 12, the inner chamber includes mirror holding portions where the mirrors are provided and a cooled portion between the mirror holding portions. The mirror holding portions and the cooled portion are connected to each other by laser welding. In the gas absorption spectrometer described in Clause 14, the mirror is less likely to be cooled.

(Clause 15) In the gas absorption spectrometer described in any one of Clauses 1 to 3 and 9 to 12, the inner chamber includes mirror holding portions where the mirrors are provided and a cooled portion between the mirrors. The mirror holding portions and the cooled portion are connected to each other by a joint composed of combination of an extendable member and a material having a thermal conductivity not higher than 1 W/m•K. In the gas absorption spectrometer described in Clause 15, vibration and position displacement of the mirror can be less and a resonator length can be kept stable. Such a problem as condensation due to cooling of the mirror can be alleviated.

Though embodiments of the present invention have been described, it should be understood that the embodiments disclosed herein are illustrative and non-restrictive in every respect. The scope of the present invention is defined by the terms of the claims and is intended to include any modifications within the scope and meaning equivalent to the terms of the claims.

What is claimed is:

1. A gas absorption spectrometer configured to measure sample gas, the gas absorption spectrometer comprising:
a resonator including at least two mirrors;
a laser light source configured to emit laser beams for irradiation of the resonator; and
a photodetector configured to detect light taken out of the resonator, wherein
the resonator includes
an inner chamber where the mirrors are accommodated, the inner chamber defining a measurement space where the sample gas is to be introduced,
an outer chamber arranged outside the inner chamber for vacuum insulation of the measurement space from outside, and
a cooler arranged within the outer chamber at a distance from the inner chamber, the cooler including an internal space where a coolant flows.

2. The gas absorption spectrometer according to claim 1, wherein
the cooler is arranged around the inner chamber to cover the inner chamber.

3. The gas absorption spectrometer according to claim 1, further comprising a thermally conductive material arranged between the inner chamber and the cooler, the thermally conductive material being configured to mediate thermal conduction between the inner chamber and the cooler.

4. The gas absorption spectrometer according to claim 3, wherein
the thermally conductive material is in a wool shape.

5. The gas absorption spectrometer according to claim 4, wherein
the thermally conductive material has a thermal conductivity not lower than 100 W/m•K.

6. The gas absorption spectrometer according to claim 3, wherein
the thermally conductive material is in a strap shape.

7. The gas absorption spectrometer according to claim 6, wherein
the thermally conductive material has a thermal conductivity not lower than 100 W/m•K.

8. The gas absorption spectrometer according to claim 3, wherein
the thermally conductive material includes gas for cooling.

9. The gas absorption spectrometer according to claim 1, wherein
the inner chamber includes
mirror holding portions where the mirrors are provided, and
a cooled portion between the mirror holding portions, and
the cooled portion is formed of a material having a radiation factor larger than a prescribed value.

10. The gas absorption spectrometer according to claim 9, wherein
the prescribed value is 0.8.

11. The gas absorption spectrometer according to claim 1, wherein
the inner chamber includes
mirror holding portions where the mirrors are provided, and
a cooled portion between the mirror holding portions, and
the cooled portion is formed of a material lower in coefficient of thermal expansion than metal.

12. The gas absorption spectrometer according to claim 1, wherein
the inner chamber includes
mirror holding portions where the mirrors are provided, and
a cooled portion between the mirror holding portions, and
the mirror holding portions are formed of a material lower in thermal conductivity than metal.

13. The gas absorption spectrometer according to claim 1, wherein
the inner chamber includes
mirror holding portions where the mirrors are provided, and
a cooled portion between the mirror holding portions, and
the mirror holding portions and the cooled portion are connected to each other by a welded bellows.

14. The gas absorption spectrometer according to claim 1, wherein
the inner chamber includes
mirror holding portions where the mirrors are provided, and
a cooled portion between the mirror holding portions, and
the mirror holding portions and the cooled portion are connected to each other by laser welding.

15. The gas absorption spectrometer according to claim 1, wherein
the inner chamber includes
mirror holding portions where the mirrors are provided, and
a cooled portion between the mirrors, and
the mirror holding portions and the cooled portion are connected to each other by a joint composed of combination of an extendable member and a material having a thermal conductivity not higher than 1 W/m•K.
